(19) United States
(12) Patent Application Publication
(10) Pub. No.: US 2018/0123181 A1
(43) Pub. Date: May 3, 2018

(54) ALL-SOLID BATTERY WITH STABLE NEGATIVE ELECTRODE INTERFACE

(71) Applicant: HYUNDAI MOTOR COMPANY, Seoul (KR)

(72) Inventors: Sam Ick Son, Suwon-si (KR); Eun Ji Kwon, Gunpo-si (KR)

(73) Assignee: HYUNDAI MOTOR COMPANY, Seoul (KR)

(21) Appl. No.: 15/418,481

(22) Filed: Jan. 27, 2017

(30) Foreign Application Priority Data
Oct. 28, 2016 (KR) 10-2016-0142181

(51) Int. Cl. H01M 10/42; H01M 4/38; H01M 10/0562

(52) U.S. Cl. CPC H01M 10/4235; H01M 2300/0071; H01M 10/0562; H01M 4/382

(57) ABSTRACT

An all-solid battery that stably maintains an interface between a solid electrolyte layer and a negative electrode long-term is provided. Specifically, the interface between the solid electrolyte layer and the negative electrode can be stably maintained long-term by using a lithium metal as the negative electrode material and disposing a sacrificial layer between the solid electrolyte layer and the negative electrode so that the negative electrode and the sacrificial layer can form an alloy.

### CROSS-REFERENCE TO RELATED APPLICATION

This application claims under 35 U.S.C. § 119(a) the benefit of and priority to Korean Patent Application No. 10-2016-0142181 filed on Oct. 28, 2016, the entire contents of which are incorporated herein by reference.

### BACKGROUND

### (a) Technical Field

The present disclosure relates to an all-solid battery to stably maintain an interface between a solid electrolyte layer and a negative electrode long-term.

### (b) Background Art

Lithium (Li) is a metal element having the lowest oxidation/reduction potential of approximately −3V. Accordingly, secondary batteries using lithium metal as a negative electrode have high energy density, with a theoretical capacity of about 3,860 mAh/g and a volumetric energy density of about 2,060 mAh/cm³.

Because lithium metal violently reacts with an electrolytic solution in the lithium secondary battery, there is a limitation on the use of lithium metal as a negative electrode material.

However, in an all-solid battery using a solid electrolyte rather than a liquid electrolyte (electrolytic solution), the electrolyte does not react with the lithium metal and thus lithium metal may effectively be used as the negative electrode material.

During repeated charging and discharging, an all-solid battery is seriously affected by dendrites created at the solid-solid interface between the solid electrolyte and the negative electrode, and therefore has a short lifespan.

Korean Laid-open Patent No. 10-2013-0067139 discloses an all-solid battery that includes a protective film including a metal ion selected from the group consisting of aluminum, iron, indium, scandium and chromium formed on a negative electrode including lithium titanium oxide to improve the stability of an all-solid battery.

The related art relates to use of lithium oxide, rather than lithium metal, as a negative electrode, to inhibit creation of lithium dendrites. However, batteries with lithium oxide anodes have deteriorated battery capacity. Accordingly, there is a need for development of technologies capable of maintaining a stable interface between the negative electrode and the solid electrolyte layer long-term, when using lithium metal as a negative electrode material.

### Patent Document

Korean Patent Laid-open No. 10-2013-0067139

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present disclosure addresses the above-described problems associated with the related art by providing a battery structure capable of maintaining a stable interface between a negative electrode and a solid electrolyte layer long-term when lithium metal is used as the negative electrode material in an all-solid battery.

It is another object of the present disclosure to provide a battery structure of an all-solid battery capable of maintaining a stable interface between a negative electrode and a solid electrolyte layer long-term while not inhibiting transfer of lithium ions between the negative electrode and the solid electrolyte layer.

The objects of the present disclosure are not limited to those mentioned above. The objects of the present disclosure will be more clearly understood from the following description and will be implemented by means described in claims and combinations thereof.

In order to accomplish the objects described above, the all-solid battery having a stabilized negative electrode interface according to an embodiment of the present disclosure may include the following configurations.

In one aspect, the present disclosure provides an all-solid battery having a stable negative electrode interface that includes a solid electrolyte layer disposed between a positive electrode and a negative electrode, and a sacrificial layer disposed between the solid electrolyte layer and the negative electrode, wherein the negative electrode is formed of a lithium metal and the sacrificial layer is formed of a material having the following properties:
(a) the material has lithium ion conductivity; and
(b) the solid solubility of the lithium metal in the sacrificial layer material is higher than solid solubility of the sacrificial layer material in the lithium metal.

In the all-solid battery having a stable negative electrode interface according to one embodiment, the sacrificial layer material may include at least one metal of gold (Au), platinum (Pt), aluminum (Al), silver (Ag) and copper (Cu).

In the all-solid battery having a stable negative electrode interface according to an example embodiment, the sacrificial layer includes an interface region contacting the negative electrode and the sacrificial layer material may form an alloy with the lithium metal in the interface region.

In the all-solid battery having a stable negative electrode interface according to an example embodiment, the sacrificial layer may have a thickness of from about 10 nm to about 500 nm, preferably form about 10 nm to about 300 nm, and more preferably from about 10 nm to about 80 nm.

The all-solid battery having a stable negative electrode interface according to an example embodiment can have a voltage variation range of ±0.005 V when a current density is 0.02 mA/cm² is applied and the battery charge/discharge time is 1,000 sec.

The all-solid battery having a stable negative electrode interface according to an example embodiment can have a voltage variation range of ±0.002 V when a current density is 0.2 mA/cm² is applied and the battery charge/discharge time is 1,000 sec.

The all-solid battery having a stable negative electrode interface according to an example embodiment can have a voltage variation range of ±0.07 V when a current density is 2 mA/cm² is applied and the battery charge/discharge time is 1,000 sec.

Other aspects and preferred embodiments of the invention are discussed below.

### BRIEF DESCRIPTION OF THE DRAWINGS

The above and other features of the present disclosure will now be described in detail with reference to certain example embodiments thereof illustrated by the accompanying drawings which are given by way of illustration only, and thus are not limitative of the present disclosure.

FIG. 1 is a schematic showing the structure of an all-solid battery according to an embodiment of the present disclosure.

FIG. 2 is a multiple-component phase diagram illustrating solid solubility of lithium (Li) and gold (Au) as a material for a sacrificial layer according to an example embodiment of the present disclosure.

FIG. 3 is a schematic showing the structure of a control cell to evaluate voltage stability in the Test Example described below.

FIGS. 4A and 4B show results of voltage variation range (a) and initial interface resistance (b) testing of the Comparative Example measured in Test 1.

FIGS. 5A and 5B show results of voltage variation range (a) and initial interface resistance (b) testing of the Example measured in Test 1.

FIG. 6 shows the results of voltage variation range testing of the Example measured in Test 2.

FIG. 7 shows the results of voltage variation range testing of the Example measured in Test 3.

FIG. 8 shows the results of voltage variation range testing measured as a function of thickness of the sacrificial layer using Test 4.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Reference is now made in detail to various embodiments of the present disclosure, examples of which are illustrated in the accompanying drawings and described below. While the disclosure will be described in conjunction with example embodiments, it will be understood that the present description is not intended to limit the disclosure to those example embodiments. On the contrary, the disclsoure is intended to cover not only the example embodiments, but also various alternatives, modifications, equivalents and other embodiments, which may be included within the spirit and scope of the invention as defined by the appended claims. In the following description of the present disclosure, a detailed description of known functions and configurations incorporated herein will be omitted when it may obscure the subject matter of the present disclosure.

Hereinafter, preferred embodiments of the present disclosure are described in detail.

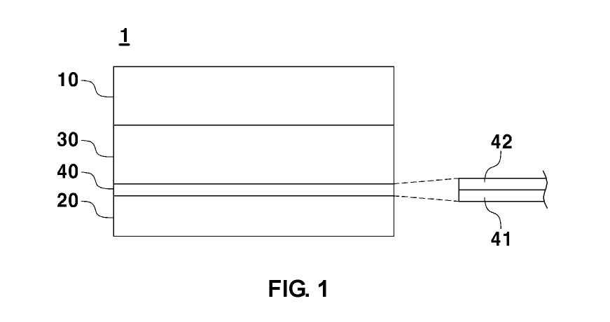

FIG. 1 illustrates an all-solid battery having a stable negative electrode interface according to an embodiment according to the present disclosure. Referring to FIG. 1, all-solid battery 1 includes a positive electrode 10 composed of a positive electrode active material, a lithium metal negative electrode 20, a solid electrolyte layer 30 disposed between positive electrode 10 and negative electrode 20, and a sacrificial layer 40 disposed between solid electrolyte layer 30 and negative electrode 20.

Solid electrolyte layer 30 may include an inorganic solid electrolyte and more particularly, the inorganic solid electrolyte may be an oxide-based solid electrolyte or a sulfide-based solid electrolyte. In an example embodiment, the oxide-based solid electrolyte may be one of the group consisting of: LISICON (Li Super Ionic CONductor) solid electrolytes such as Li₃PO₄, Li₂ZnGeO₄, Li₄CoGeO₄; garnet solid electrolytes such as Li₇La₃Zr₂O₁₂, Li₅La₃Ta₂O₁₂ and Li₅La₃Nb₂O₁₂; perovskite solid electrolytes such as LiLaTiO₃ and LiNbO₃; and glass-ceramic solid electrolytes such as Li—Al—Ti—P—O and Li—Al—Ge—Ti—P—O. In an example embodiment, the sulfide-based solid electrolyte may be one of the group consisting of: thio-LISICON solid electrolytes such as Li₃PS₄, Li₄GeS₄ and Li₄GePS₄; and glass-ceramic solid electrolytes such as Li₂S—P₂S5 and GeS₂—Li₂S. In addition to these compounds, LiF, Li₃N, Li₃P and the like may be used as the inorganic-based solid electrolyte.

The all-solid battery having a stable negative electrode interface according to an example embodiment further includes sacrificial layer 40 between lithium metal negative electrode 20 and solid electrolyte layer 30 so that the interface between the negative electrode and the solid electrolyte layer can be stably maintained during charge/discharge of the all-solid battery. A detailed description of sacrificial layer 40 is given below.

Sacrificial layer 40 may be formed using a material having the following properties:

(a) the material has lithium ion conductivity; and

(b) solid solubility of the lithium metal in the sacrificial layer material is higher than solid solubility of the sacrificial layer material in the lithium metal.

In an example embodiment, the sacrificial layer material may include at least one of gold (Au), platinum (Pt), aluminum (Al), silver (Ag) and copper (Cu).

As used herein, the term “solid solubility” refers to a solubility in a solid solution, showing how much one metal can dissolve the other metal.

Property (a) enables lithium ions to move smoothly between negative electrode 20 and solid electrolyte layer 30.

Property (b) enables the negative electrode material to be easily dissolved in the sacrificial layer material, while the sacrificial layer material has limited ability to dissolve in the negative electrode material. Sacrificial layer 40 may be divided into an interface region 41 and a bulk region 42, as shown in FIG. 1.

In interface region 41 where sacrificial layer 40 contacts negative electrode 20, lithium metal from negative electrode 20 is dissolved in the sacrificial layer material to form an alloy. In an example embodiment, alloy formation may occur due to pressure applied when forming a battery cell, where positive electrode 10, negative electrode 20, solid electrolyte layer 30 and sacrificial layer 40 are compressed together. The present disclosure is not limited to this process, and alloy formation may be carried out by heating using an oven, applying both pressure and heat, or other methods.

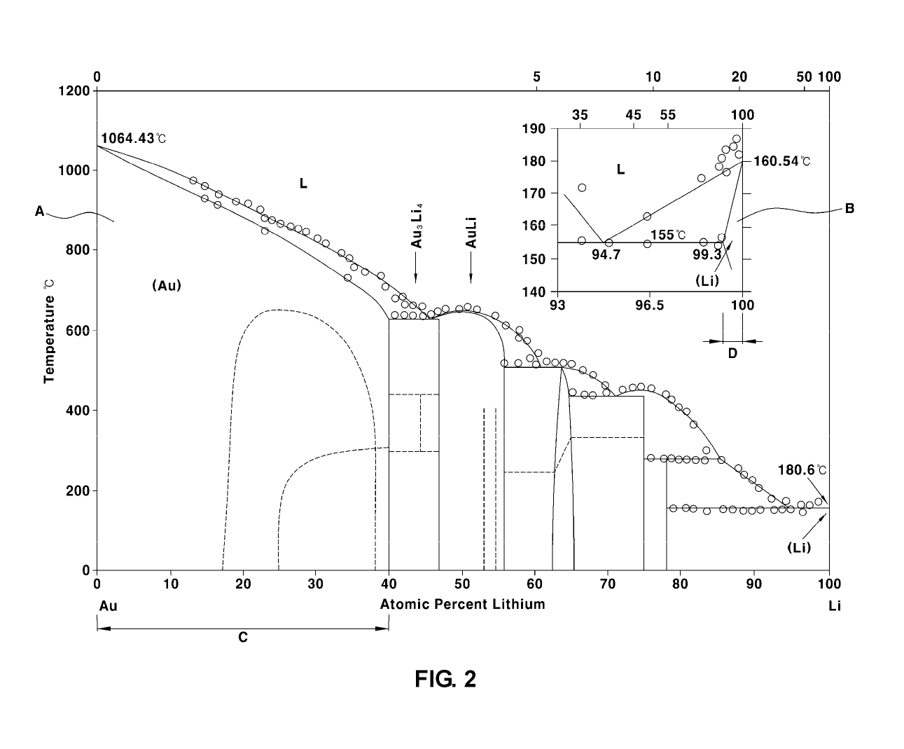

Alloy formation between the lithium metal and the sacrificial layer material in the interface region, particularly where the sacrificial layer material is gold (Au) with both properties (a) and (b) is further described below. FIG. 2 is a phase diagram for gold (Au) and lithium (Li).

Referring to FIG. 2, in region A, gold (Au) can form an Au—Li solid solution with lithium (Li). That is, in a region rich in gold (Au) (sacrificial layer 40 of the present disclosure), lithium (Li) can be dissolved until the atomic percent with respect to gold (Au) is 40% (C).

In contrast, in region B, lithium (Li) can form a Li—Au solid solution with gold (Au). That is, in a region rich in lithium (Li) (negative electrode 20 of the present disclosure), gold (Au) can be dissolved until the atomic percent with respect to lithium (Li) is 0.7% (D).

As described above, because solid solubility of lithium (Li) in gold (Au) is greater than the solid solubility of gold (Au) in lithium (Li), the lithium metal is dissolved in gold to form an alloy in the interface region of the sacrificial layer.

Because the sacrificial layer material present in a region outside interface region 41 of sacrificial layer 40 is not dissolved in the lithium metal or is limitedly dissolved therein, it cannot form an alloy. Accordingly, a bulk region 42 of sacrificial layer 40 exists that is differentiated from interface region 41 and is composed primarily of the sacrificial layer material. Bulk region 42 prevents growth of dendrites on negative electrode 20, to stably maintain the interface between solid electrolyte layer 30 and negative electrode 20. Interface region 41 minimizes resistance which may be generated due to sacrificial layer 40 disposed between solid electrolyte layer 30 and negative electrode 20, and improves electrical contact between solid electrolyte layer 30 and negative electrode 20.

Accordingly, in an example embodiment, because lithium metal is used as the negative electrode 20 material, capacity of the all-solid battery can be improved. Although sacrificial layer 40 is inserted, electrical contact between negative electrode 20 and solid electrolyte layer 30 is not deteriorated. The interface between negative electrode 20 and solid electrolyte layer 30 can be stably maintained long-term without deterioration in capacity and lifespan can be significantly increased.

Sacrificial layer 40 can be formed by coating the sacrificial layer material to a thickness of from about 10 nm to about 500 nm, preferably from about 10 nm to about 300 nm, and more preferably from about 10 nm to about 80 nm. When the thickness of sacrificial layer 40 is less than about 10 nm, it is difficult to distinguish the interface region from the bulk region, and it is thus impossible to stably maintain the interface between solid electrolyte layer 30 and negative electrode 20. On the other hand, when the thickness of sacrificial layer 40 exceeds 500 nm, high resistance may be generated at the interface between solid electrolyte layer 30 and negative electrode 20 due to insertion of sacrificial layer 40. An all-solid battery according to an embodiment of the present disclosure including the configurations described above can have a voltage variation range of ±0.005 V when the sacrificial layer thickness is between about 10 nm and about 80 nm, a current density of 0.02 mA/cm², and a charge/discharge time of 1,000 sec.

An all-solid battery according to another embodiment can have a voltage variation range of ±0.002 V when the sacrificial layer thickness is between about 10 nm and about 80 nm, a current density of 0.2 mA/cm², and a charge/discharge time of 1,000 sec.

An all-solid battery according to yet another embodiment of the present disclosure can have a voltage variation range of ±0.07 V when the sacrificial layer thickness is between about 10 nm and about 80 nm, a current density of 2 mA/cm², and a charge/discharge time of 1,000 sec.

Hereinafter, the present disclosure will be described in more detail with reference to specific examples. However, the examples are provided only for illustration of the present disclosure and the scope of the present disclosure is not limited to the examples.

### EXAMPLE

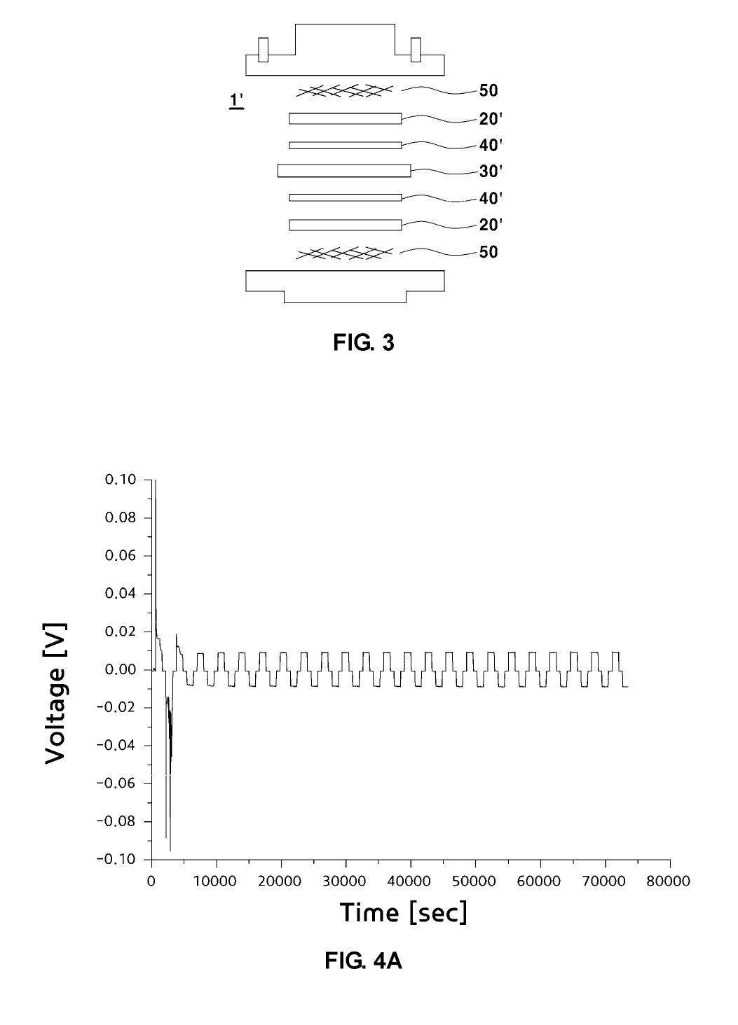

To confirm whether or not voltage stability of an example embodiment of an all-solid battery is improved by insertion of the sacrificial layer, the control cell 1′ shown in FIG. 3 was produced.

Control cell 1′ was designed to more clearly identify the relationship between voltage stability and a sacrificial layer 40′ and prevents oxidation of the lithium metal negative electrode 20′. Control cell 1′ has a first current collector 50, a first lithium metal layer 20′, a first sacrificial layer 40′, a solid electrolyte layer 30′, a second sacrificial layer 40′, a second lithium metal layer 20′ and a second current collector 50 laminated together in this order from the top.

Sacrificial layer 40′ was formed by coating both surfaces of solid electrolyte layer 30′ with gold (Au) to a thickness of about 80 nm on each surface. The lithium metal was a lithium foil and the current collector was a nickel mesh.

The current collector, the lithium metal and the sacrificial layer-coated solid electrolyte layer were laminated as shown in FIG. 3 and pressed to form control cell 1′.

### Comparative Example

A control cell 1′ was produced using the same materials and in the same manner as in the Example, except that no sacrificial layer was incorporated in control cell 1′.

Testing of the Example and Comparative Example

Current was applied to the control cells 1′ of the Example and the Comparative Example under the following conditions and the resulting voltage was measured to confirm whether or not over-voltage was generated.

(1) Test 1—Evaluation of Voltage Stability at Current Density of 0.02 mA/cm²

In order to evaluate the long-term interface characteristics of the control cells 1′ of the Example and the Comparative Example, voltage was measured at a current density of 0.02 mA/cm² and a charge/discharge time of 1,000 sec. In addition, in order to confirm the initial interface resistance of the control cells 1′ of the Example and the Comparative Example, resistance was measured using an impedance test method.

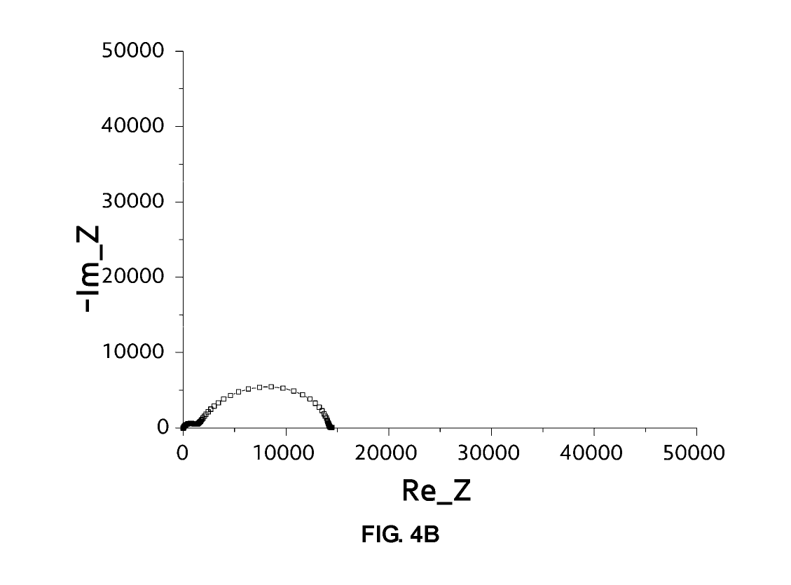

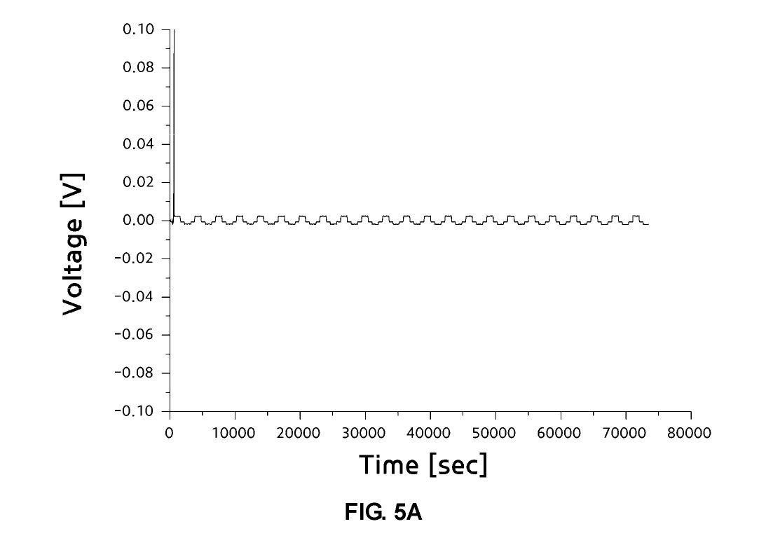

FIG. 4 shows test results for the control cell 1′ of the Comparative Example and FIG. 5 shows test results for the control cell 1′ of the Example.

As shown in FIG. 4(b) and FIG. 5(b), the initial interface resistance of the Comparative Example is 4.45×10³ Ω·cm², and the initial interface resistance of the Example is 8.12×10³ Ω·cm². Thus, the insertion of the sacrificial layer causes a slight increase in initial interface resistance. However, after alloy formation between the sacrificial layer and the lithium metal negative electrode in the control cell 1′ of the Example, as current flows, the voltage variation range (FIG. 5(a)) significantly decreases compared to the control cell 1′ of the Comparative Example (FIG. 4(a)). These results indicate that the increase in initial interface resistance does not significantly affect performance of the Example all-solid battery.

As can be seen from FIG. 4(a) and FIG. 5(a), the voltage variation range of the Comparative Example is about ±0.01 V, whereas the voltage variation range of the Example is significantly improved to about ±0.005 V. These results indicate that the sacrificial layer enables long-term stable maintenance of the interface between the solid electrolyte layer and the negative electrode.

(2) Test 2—Evaluation of Voltage Stability at Current Density of 0.2 mA/cm²

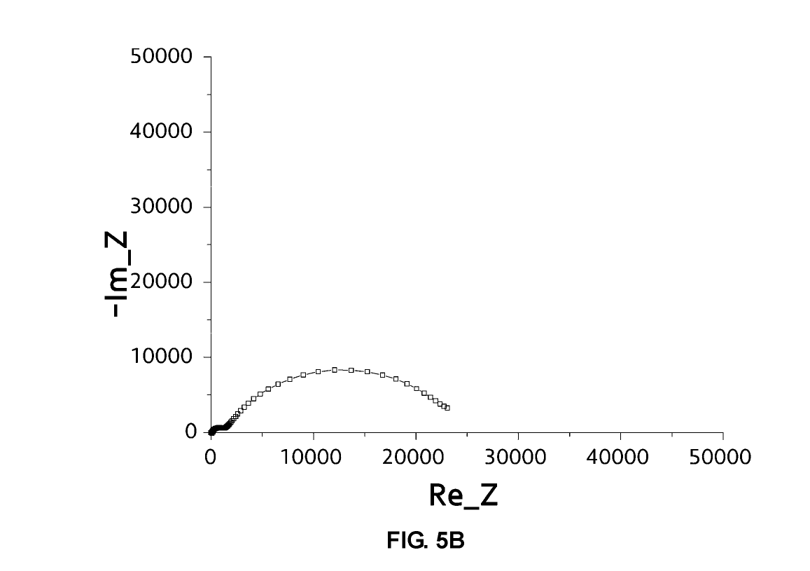

Voltage stability of the control cell 1′ of the Example was evaluated in the same manner as in Test 1, except that current was applied at a current density of 0.02 mA/cm² to the control cell 1′. The results are shown in FIG. 6.

As can be seen from FIG. 6, when the current density is 0.2 mA/cm², the voltage variation range is about ±0.002 V, which indicates that the interface between the solid electrolyte layer and the negative electrode is stably maintained long-term.

(3) Test 3—Evaluation of Voltage Stability at Current Density of 2 mA/cm²

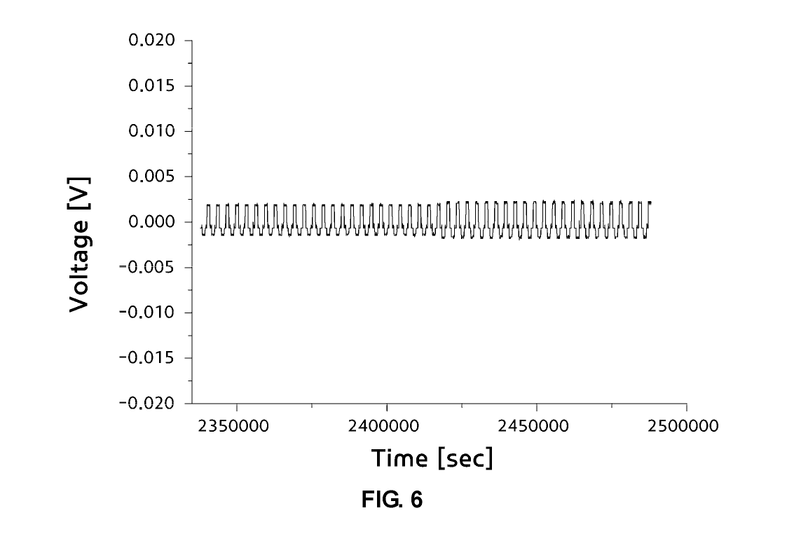

Voltage stability of the control cell 1′ of the Example was evaluated in the same manner as in Test 1, except that current was applied at a high current density of 2 mA/cm² to the control cell 1′. The results are shown in FIG. 7.

As can be seen from FIG. 7, when the current density is 2 mA/cm², the voltage variation range is about ±0.07 V until the number of charge/discharge cycles is about 2800, which indicates that the interface between the solid electrolyte layer and the negative electrode is stably maintained long-term.

(4) Test 4—Evaluation of Voltage Stability as a Function of the Thickness of Sacrificial Layer

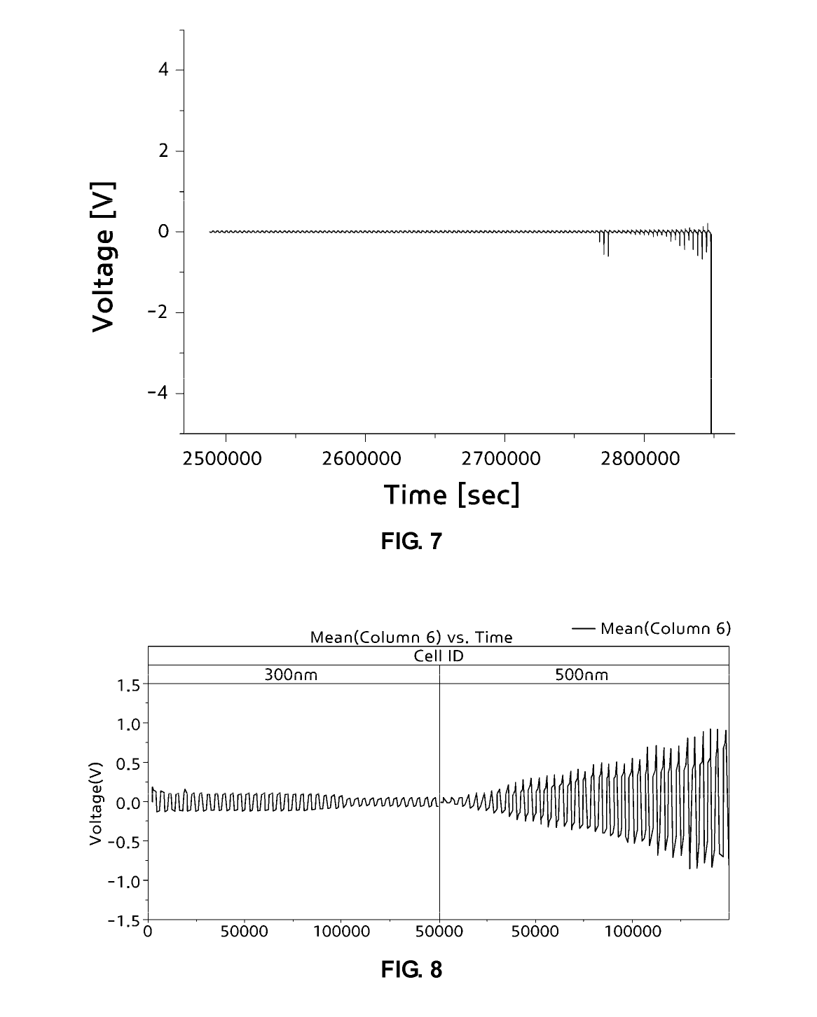

Control cells were produced in the same manner as in the Example, except that the thicknesses of the sacrificial layers were 300 nm and 500 nm. Voltage stability of the control cell 1′ of Test 4 was evaluated in the same manner as in Test 1. The results are shown in FIG. 8.

As can be seen from FIG. 8, when the thickness of the sacrificial layer is 300 nm, the voltage variation range is about ±0.2 V or less, which means that the interface between the solid electrolyte layer and the negative electrode can be stably maintained. When the thickness of the sacrificial layer is 500 nm, the voltage variation range is relatively narrow, i.e., about ±0.5 V or less until time reaches about 50,000 sec. However, as time goes by, the voltage variation range increases and resistance at the interface slightly increases.

The embodiments of the present disclosure include the aforementioned configurations and have the following effects.

The all-solid battery according to one embodiment of the present disclosure can prevent generation of high resistance at the interface between the negative electrode formed of a lithium metal and the solid electrolyte layer because the interface therebetween is stably maintained long-term.

The all-solid battery according to the embodiment of the present disclosure has a significantly decreased voltage variation range during charge/discharge of the all-solid battery and a correspondingly significantly lengthened lifespan because high resistance is not generated at the interface between the negative electrode and the solid electrolyte layer.

The effects of the embodiments of the present disclosure are not limited to those described above. It should be understood that the effects of the embodiment of the present disclosure include all effects that can be inferred from the description given above.

The invention has been described in detail with reference to example embodiments thereof. However, it will be appreciated by those skilled in the art that changes may be made in the embodiments without departing from the principles and spirit of the invention, the scope of which is defined in the appended claims and their equivalents.

What is claimed is:

1. An all-solid battery having a stable negative electrode interface comprising:
a positive electrode;
a negative electrode composed of lithium metal;
a solid electrolyte layer disposed between the positive electrode and the negative electrode; and
a sacrificial layer disposed between the solid electrolyte layer and the negative electrode;
wherein the sacrificial layer is formed of a material having the following properties:
(a) the material has lithium ion conductivity; and
(b) the solid solubility of lithium metal in the sacrificial layer material is higher than solid solubility of the sacrificial layer material in the lithium metal.

2. The all-solid battery having a stable negative electrode interface according to claim 1, wherein the sacrificial layer material comprises at least one metal of gold (Au), platinum (Pt), aluminum (Al), silver (Ag) and copper (Cu).

3. The all-solid battery having a stable negative electrode interface according to claim 1, wherein the sacrificial layer comprises an interface region contacting the negative electrode,
and wherein the sacrificial layer material forms an alloy with the lithium metal in an interface region.

4. The all-solid battery having a stable negative electrode interface according to claim 1, wherein the sacrificial layer has a thickness of 10 nm to 500 nm.

5. The all-solid battery having a stable negative electrode interface according to claim 1, wherein the sacrificial layer has a thickness of form about 10 nm to about 300 nm.

6. The all-solid battery having a stable negative electrode interface according to claim 1, wherein the sacrificial layer has a thickness of about 10 nm to about 80 nm.

7. The all-solid battery having a stable negative electrode interface according to claim 1, wherein the all-solid battery has a voltage variation range of ±0.005 V when a current density is 0.02 mA/cm² is applied and battery charge/discharge time is 1,000 sec.

8. The all-solid battery having a stable negative electrode interface according to claim 1, wherein the all-solid battery has a voltage variation range of ±0.002 V when a current density is 0.2 mA/cm² is applied and the battery charge/discharge time is 1,000 sec.

9. The all-solid battery having a stable negative electrode interface according to claim 1, wherein the all-solid battery has a voltage variation range of ±0.07 V when a current density is 2 mA/cm² is applied and the battery charge/discharge time is 1,000 sec.
